(19) United States
(12) Patent Application Publication
(10) Pub. No.: US 2007/0242851 A1
(43) Pub. Date: Oct. 18, 2007

(54) Loudspeaker

(76) Inventors: Ilkka Turunen, Espoo (FI); Sami Penttila, Jyvaskyla (FI)

Correspondence Address: JOEL D. SKINNER, JR.;SKINNER AND ASSOCIATES, 212 COMMERCIAL ST., HUDSON, WI, 54016, US

(21) Appl. No.: 10/586,921

(22) PCT Filed: Jan. 17, 2005
(86) PCT No.: PCT/FI05/00023

§ 371 Date: Apr. 12, 2007

(30) Foreign Application Priority Data
Jan. 22, 2004 (FI) 20040093

(51) Int. Cl. H04R 7/06

(52) U.S. Cl. 381/431

(57) ABSTRACT

The invention relates to a loudspeaker, particularly a so-called planar loudspeaker, the vibrating diaphragm of which is essentially planar and is attached by its edges to the body (3) of the loudspeaker. There is a resilient intermediate piece (2) between the diaphragm (1) and the body (3), there is a resilient intermediate piece (2), which is located essentially around the entire edge area of the diaphragm (1). The intermediate piece (2) may be, for example, of a resilient rubber or plastic-based material.

The present invention relates to a loudspeaker, more specifically particularly to a so-called planar loudspeaker.

Conventional loudspeaker solutions are such, in which a cone manufactured from stiff cardboard or similar acts as the diaphragm of the loudspeaker element. The cone is attached flexibly by its outer edges to the body of the loudspeaker, while in the centre of the cone, at the foot of the cone there is a voice coil, which moves in an magnetic field. Solutions are known, which the cone is manufactured from a material other than cardboard.

A second known solution is disclosed, for example, in US patent publication 3,509,290, which uses a planar diaphragm attached to the edges of the loudspeaker enclosure. The manufacturing material of the diaphragm is expanded polystyrene. According to the solution, the loudspeaker includes several different kinds of baffles, which are use to achieve sounds of difference pitches. A drawback is a quite complicated construction, which brings the additional drawback of distortion appearing, due to the mutual mixing of the sounds.

A loudspeaker solution is known from Finnish patent 94203, which is intended to improve the output/efficiency ratio of a loudspeaker and to reduce distortion. In the loudspeaker structure, there is a planar diaphragm, which is attached by its edges to the loudspeaker enclosure. The diaphragm is equipped with a baffle in its central area, so that the diaphragm is more resilient, for example, thinner, near to the baffle, than in the area farther away. There is still room for improvement in the efficiency of the solution and in the formation of distortion.

The present invention is intended to avoid the drawbacks of the solutions according to the prior art, and to create a loudspeaker which is more efficient than known loudspeakers.

The aforementioned and other advantages and benefits of the present invention are achieved in the manner stated to be characteristic in the accompanying Claims.

The invention is illustrated in greater detail, with reference to the following drawings, in which:

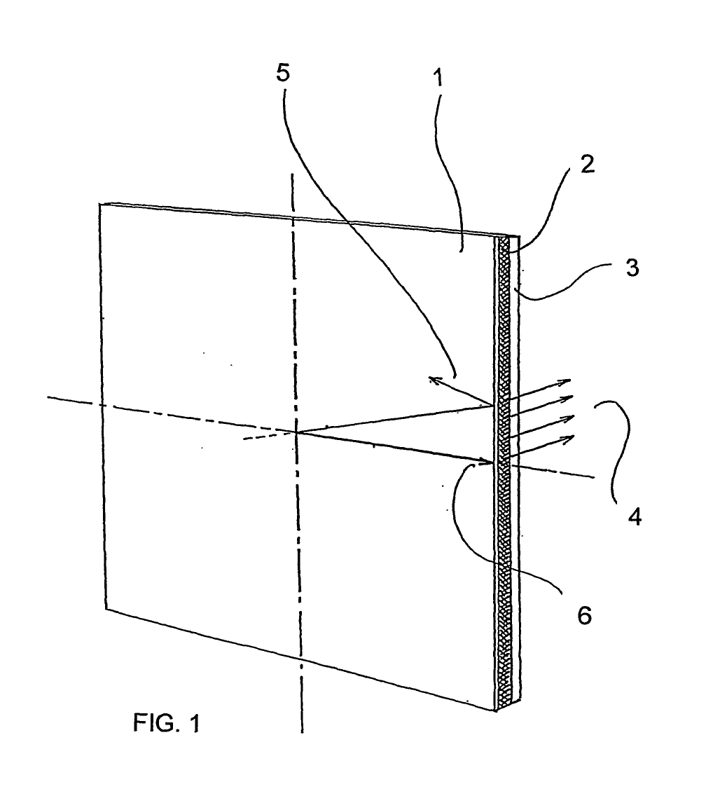

FIG. 1 shows a partial axonometric view of the loudspeaker construction according to the invention; and

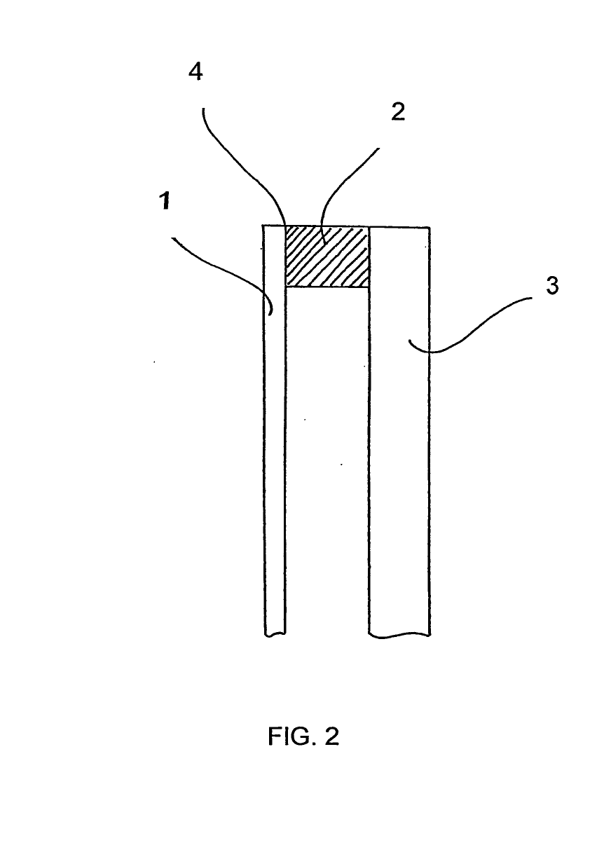

FIG. 2 shows an enlargement of the attachment, according to the invention, of the diaphragm to the body.

In the figures, the invention is shown only on the basis of certain general principles, which are significant in terms of the present invention. Thus, the overall construction of the loudspeaker can be as desired and is not depicted here. The essential feature is that the loudspeaker is a so-called planar loudspeaker, the diaphragm of which is thus a planar diaphragm.

Conventionally, a planar diaphragm is attached rigidly by its edges to the body structures. Such an attachment causes a counter-reflex against the body. According to the present invention, the attachment is now resilient. A counter-reflex does not arise, or arises only to an insignificant degree. In practice, it has been shown experimentally that, despite the resilient attachment, the diaphragm will retain its shape in the attachment area, even though the diaphragm also vibrates in the conventional manner.

Thus, in FIG. 1 the diaphragm is marked with the reference number 1. As can be seen from the figures, the question is of a planar diaphragm. The diaphragm 1 is attached by its edges to the body 3 of the loudspeaker, using a strip 2 of a resilient suspension substance. The arrows marked with the reference number 4 are intended to illustrate that the kinetic energy is absorbed by the resilient suspension substance. The edge reflex that appears in the loudspeaker structure is, in turn, marked with the reference number 5, while the arrow marked with the reference number 6 is intended to show the direction of the progression of the wave motion.

The use of a construction like that shown thus permits the cancelling of the opposite-phase waves of the edge-reflex to be reduced. As a result, the detrimental resonances of the vibrating diaphragm are reduced, thus creating a pure sound. Another result of the construction of the invention is that the amount of energy required to produce the intended vibrations is smaller than in known constructions, thus giving the loudspeaker a higher efficiency than that of known constructions.

FIG. 2 shows a cross-section of the edge of one construction according to the invention. The diaphragm 1 is attached to the body 3 of the loudspeaker by a relatively narrow, resilient strip 2. Because the intermediate piece 2 is resilient, it gives way to a limited extent to the movement causing the vibrations in the diaphragm.

The diaphragm 1 used in the construction according to the invention is of any suitable conventional material. The resilient intermediate piece 2 is also of a conventional material, in the sense that its resilient properties can derive either from the properties of the material itself, or else a structure can be constructed for the resilience, in which resilience is created in some other way than by using the properties of the material itself. In practice, it seems to be entirely acceptable to use a resilient material, such as a rubber or plastic-based material, such as a cellular plastic, or else the resilience can be achieved by using a fabric-like or similar material, which can be either a natural material, or a synthetic material.

Adaptations are possible, which remain within the scope of the protection of the basic idea of the invention and the accompanying Claims.

1. A loudspeaker, particularly a so-called planar loudspeaker, the vibrating diaphragm of which is essentially planar and is attached by its edges to the body (3) of the loudspeaker, characterized in that there is a resilient intermediate piece (2) between the diaphragm (1) and the body (3).

2. A loudspeaker according to claim 1, characterized in that the intermediate piece (2) is located essentially around the entire edge area of the diaphragm (1).

3. A loudspeaker according to claim 1, characterized in that the intermediate piece (2) is formed from a resilient material.

4. A loudspeaker according to claim 3, characterized in that the intermediate piece (2) is a strip of a resilient rubber or plastic-based material, or it is formed from a woven type of natural or synthetic material.
